(19) United States
(12) Patent Application Publication
(10) Pub. No.: US 2024/0166864 A1
(43) Pub. Date: May 23, 2024

(54) POLYMER COMPOSITE COMPRISING MICRONIZED FELDSPAR

(71) Applicant: Rosiro Intellectual Property B.V., Gravenhage (NL)

(72) Inventor: Daniel Eric Lynch, Norwich (GB)

(73) Assignee: Rosiro Intellectual Property B.V., Gravenhage (NL)

(21) Appl. No.: 17/991,569

(22) Filed: Nov. 21, 2022

(51) Int. Cl. C08L 67/04

(52) U.S. Cl. CPC C08L 67/04

(57) ABSTRACT

Polymer composites including feldspar having improved processability and biodegradability without loss of strength or flexibility are described. The polymer composites can be moulded into disposable articles such as coffee capsules, cutlery, straws, drink stirrers, food trays, single-serve packaging, such as a cup, cap, container and/or lid, or any other single-use item.

### BACKGROUND

The use of starch and/or protein containing natural materials in biocomposite resins is well known.

When incorporating starch and/or protein containing materials into plastics there is generally a requirement to plasticize the starch/protein molecules so that they do not agglomerate under thermal treatment thus reducing their processability. As described in Yachuan Zhang and Curtis Rempel (2012), Retrogradation and Antiplasticization of Thermoplastic Starch, Thermoplastic Elastomers, Prof. Adel El-Sonbati (Ed.), ISBN: 978-953-51-0346-2; “The role of plasticizers is to attract the water molecules around them, reduce the intermolecular interactions between the starch molecules, and then increase the flexibility of native starch.”

This article also states “Three theories have been proposed to account for the mechanisms of plasticization. These are lubricity theory, gel theory, and free volume theory. Lubricity theory proposes that the plasticizer acts as a lubricant and lubricates movements of the macromolecules over each other. Gel theory proposes that the plasticizer disrupts the interaction of starch chain bonds. Free volume theory proposes that plasticizer increases free volume between the starch chains and lowers its glass transition temperature (Tg). The commonality of these is that plasticizer is considered to interpose itself between the starch chains and reduce the forces holding the chains together.”

Multiple studies have concluded that at least 20% by weight plasticizer is required in the starch to achieve successful plasticization with most concluding that levels of 30% by weight plasticizer content are ideal.

However, it is important to understand that plasticizers for starch/protein containing materials are distinctly different from the plasticizers used in the biodegradable polymers that are also analogous ingredients in the construction of biocomposite resins. These types of plasticizers (for the biodegradable polymers) are commonly (but not limited to) alkyl citrates, whereas plasticizers for starch/protein containing materials are normally (but not limited to) polyfunctional alcohols or polyols, although two plasticizers that have benefits for both materials are polyethylene glycol and polyvinyl alcohol.

Glycerine/glycerol is the most common plasticizer used for plasticizing starch/protein containing materials because this liquid (at room temperature) offers good elongation but low tensile strength, which is good for film applications and low tensile strength can be compensated by incorporation with a high tensile strength biopolymer, whereas a solid (at room temperature) plasticizer like sorbitol offers good tensile strength but lower elongation (Bioresource Technology 2009, 100, 3076-3081).

Alternatively, the natural sugars in materials such as apple flour and grape pomace can also have a plasticizing effect and thus these materials do not require added plasticizer (BioResources 2019, 14, 3210-3230).

It is commonly accepted that the use of a plasticizer for starch/protein containing materials is essential for the successful production of biocomposite resins constructed using biodegradable polymers, which may or may not have their own inclusion of a plasticizer targeted to their specific processing requirements.

The use of mineral fillers is also well known in all plastics and have specifically been incorporated as an ingredient in biocomposite resins with glycerine/glycerol plasticized starch/protein containing materials to improve strength and rigidity for applications of more rigid articles.

Common mineral fillers include calcium carbonate (chalk), clay (talc) and silicon dioxide/titania dioxide, which offer white pigmentation, price reduction and increased biodegradability when incorporated into biodegradable polymers (for example Journal of Applied Polymer Science 2020, 137, 48939 (9 pages)).

Feldspar minerals with compositions that range between NaAlSi₃O₈ and KAlSi₃O₈ are known as alkali feldspars. They include albite (NaAlSi₃O₈), anorthoclase ((Na,K)AlSi₃O₈), sanidine ((K,Na)AlSi₃O₈), orthoclase (KAlSi₃O₈), and microcline (KAlSi₃O₈).

Nepheline syenite is a naturally occurring (consisting mainly of nepheline and alkali feldspar), silica deficient, sodium-potassium alumina silicate that can contain less than one tenth of a percent crystalline silicon dioxide.

Commercial applications for nepheline syenite powders are as functional fillers and extenders for paints, coatings, adhesives, sealants, and inks. This is made possible by a Mohs hardness of 6, compared to half that value for calcium carbonate (chalk) and 1 for clay (talc) or 1.5-2 for bentonite clay.

Micronized nepheline syenite (D₅₀<10 micrometres) has a surface area of between 1-5 m²/g and an oil absorbency capacity of 20-30 g/100 g. Furthermore, nepheline syenite is chemically alkaline (pH˜10).

Nepheline syenite is also used as both a flux and white pigment in ceramics.

Nepheline syenite is listed (FCM substance number 684) as a polymer additive in Annex 1 Table 1 of Commission Regulation (EU) No 10/2011 on plastic materials and articles intended to come into contact with food.

The use of feldspars overall in thermoplastics is—due to the high Mohs hardness—limited to a few applications like antiblocking in polyolefin films, and light and thermal management in agricultural films.

U.S. Pat. No. 9,085,671 lists either nepheline syenite or feldspar as a partial or total replacement filler for natural wood powder in plastic that is used as an artificial wood product in the form of decking, fencing and architectural trim.

### SUMMARY

Embodiments of the present invention relate to polymer composites including feldspar.

Further, embodiments of the present invention improve processability and biodegradability of biocomposite resins, without loss of strength or flexibility. Moreover, embodiments of the present invention describe polymer composites that can be moulded into disposable articles such as coffee capsules, cutlery, straws, drink stirrers, food trays, single-serve packaging, such as a cup, cap, container and/or lid, or any other single-use items having sufficient strength to form disposable articles with a wall thickness larger than 250 μm.

Also provided is a process for preparing the polymer composite, an intermediate for preparing the polymer composite and articles comprising the polymer composite.

### DETAILED DESCRIPTION

It has been found that with the addition of at least 1% by of weight of micronized feldspar, optionally together with an appropriate additive, there is an advantageous attraction between the alkaline (pH˜10) nepheline syenite and weakly acidic (pH=4-7) carbohydrates (including starch)/protein materials that decreases agglomeration of the starch/protein molecules, thus allowing good processability and aiding biodegradability of the overall biocomposite resin.

In fact, in an embodiment, the nepheline syenite (pH>7) and polyols (which have pH<7), or any other acidic plasticizer added separately to improve the processing of the starch/protein containing materials, are not used together in combination with each other in a single-pass process because under thermal extrusion processes these two ingredients may react and potentially form a highly-viscous, chewing gum type mass that can hinder the workings of the extruder/compounder.

Another advantage to the combination of micronized nepheline syenite powder and natural products containing starch and/or protein without the presence of any polyol plasticizer relates to their high water-solubility. It has been found that combinations without the presence of a polyol plasticizer exhibit significantly lower overall migration amounts under treatment from the simulants (A-D1) listed in Annex Ill of Table 1 of Commission Regulation (EU) No 10/2011 on plastic materials and articles intended to come into contact with food.

Comparatively, urea has been examined as a plasticizer in thermoplastic sugar beet pulp film strips formed by extrusion in Bioresource Technology 2009, 100, 3076-3081, although not specifically examined because it is a basic (in terms of Bronsted-Lowry acid-base theory) molecule but more so due to its hydrogen-bonding capabilities as it was examined along with a number of other polyols. The results showed that urea “gave higher ultimate tensile stress than glycerol for a comparable strain at break”. In contrast, ethanolamine, diethanolamine, and triethanolamine (all Bronsted-Lowry bases) gave results less than glycerol. The thermoplastic sugar beet pulp was not incorporated into any other plastic nor was any mineral filler used. Further see Yachuan Zhang and Curtis Rempel (2012), Retrogradation and Antiplasticization of Thermoplastic Starch, Thermoplastic Elastomers, Prof. Adel El-Sonbati (Ed.), ISBN: 978-953-51-0346-2 for comments on the hydrogen-bonding properties of urea and its use as a plasticizer for starch.

U.S. Pat. No. 4,242,251 covers the use of feldspar minerals coated with small molecule acids for use as fillers in plastics. In this patent the mineral particles are treated with small molecule acids so that “a strong bond may be formed between the acid and the metal ion on the surface of said mineral particle”. Thus, the interaction is not acid/base in nature but the formal chemical formation of a metal co-ordination complex.

The hardness of the nepheline syenite further aids strength of the biocomposite resin, more so than chalk or talc fillers.

Natural materials containing carbohydrates/proteins that are unprocessed (or are processed but not highly refined) further contain oils that can have a beneficial plasticizing effect on the polymer but may also cause processing issues by leaving burnt deposits on thermoforming equipment. The oil absorbency of nepheline syenite has also been found to be advantageous in this respect helping to reduce natural oil migration and burning.

US 2010/0003431 lists both feldspar and nepheline syenite as being fillers in a plastic layer that is coupled to a fibre containing layer where the listed fibres are from natural sources.

Another common ingredient in the formulation of biocomposite resins is the use of compatibilizers. These materials are designed to improve the surface attraction of the hydrophilic ingredients, such as the natural materials and mineral fillers, and the hydrophobic biopolymers. They can also be utilized to blend immiscible polymers (Advances in Polymer Technology 1992, 11, 249-262).

A common type of compatibilizer is the maleic anhydride grafted variant of one of the biopolymers used in the biocomposite resin formulation, for example maleic anhydride grafted polylactide resin with polylactide resin (for example Composite Interfaces 2018, 25, 515-538) or maleic anhydride grafted poly(butylene succinate) with poly(butylene succinate) resin (for example Waste and Biomass Valorization 2020, 11, 3775-3787).

Other chemicals that can be grafted on to the biopolymers to create a compatibilizer include acrylic acid or derivates such as methacrylic acid, acrylate derivatives such as butyl acrylate, methacrylate derivatives such as glycidyl methacrylate, maleimide and its derivatives such as N-phenyl maleimide, acrylamide and its derivatives, styrene and its derivatives, and itaconic acid and its itaconate derivatives.

Another type of compatibilizer is poly(2-ethyl-2-oxazoline) (for example U.S. Pat. No. 6,632,925).

In an embodiment, a plasticizer for the starch and/or protein containing material is at most 40% by weight of the starch and/or protein containing material, preferably at most 35%, more preferably at most 30%, even more preferably at most 20%, even more preferably at most 10%, most preferably at most 5%, for instance at most 3%.

Biocomposite resins have three essential ingredient types: biopolymers, starch/protein containing materials, and feldspars; with the option of a fourth: additives.

In an embodiment, the biodegradable biopolymer is provided in an amount of 5-80% by weight of the overall weight, preferably 10-60%, more preferably 15-40%, even more preferably 20-35%, for instance 30%.

In an embodiment, the micronized feldspar is provided in an amount of 10-80% by weight of the overall weight, preferably 15-60%, more preferably 20-50%, even more preferably 25-40%, for instance 5-35%.

In an embodiment, the starch and/or protein containing material is provided in an amount of 10-80% by weight of the overall weight, preferably 15-60%, more preferably 20-50%, even more preferably 25-40%, for instance 35%.

Biopolymers

Biopolymers may be produced directly from renewable resources or can be from oil-based resources. Desirably, the biopolymers are homopolymers, block copolymers, grafted copolymers or random copolymers. Preferably the biopolymers comprise one or more repeat units containing hydrolysable linkages, or combinations thereof, such as one or more units selected from the group comprising glycolic acid (for example the dimer of glycolic acid, glycolide), lactic acid (for example the dimer of lactic acid, lactide), hydroxy alkanoic acids, such as hydroxybutyric acid and hydroxyvaleric acid, caprolactone, p-dioxanone, trimethylene carbonate, butylene succinate, butylene adipate, monosaccharides, such as hexoses, glucose, fructose, and galactose, as well as pentoses, such as ribose and deoxyribose, dicarboxylic acid anhydrides, such as anhydrides of sebacic acid and hexadecanedioic acid, enantiomers thereof, such as L-lactic acid or D-lactic acid, esters of saccharides, such as cellulose acetate, and combinations thereof.

Typically, the biopolymers comprise polymers chosen from poly(lactic acid) (PLA), DL-polylactide (DLPLA), D-polylactide (DPLA), L-polylactide (LPLA), polyglycolide (PGA), poly(DL-lactide-co-glycolide) (PGLA), poly(ethylene glycol-co-lactide), polycaprolactone (PCL), poly(L-lactide-co-caprolactone-co-glycolide), poly(dioxanone) (PDO), poly(trimethylene carbonate), polyglyconate (for example a copolymer of glycolide and trimethylene carbonate), polyhydroxyalkanoates (PHA), polyhydroxybutyrate (PHB), polyhydroxybutyrate-co-hydroxyvalerate (PHBV), polyhydroxyvalerate (PHV), polysaccharides (for example homopolysaccharides and heteropolysaccharides), modified polysaccharides such as cellulose acetate and chitosan, aliphatic and aromatic copolyesters, poly(1,4-butylene succinate) (PBS), poly(1,4-butylene adipate) (PBA), (poly butadiene adipate co-terephthalate polymer (PBAT), poly(butylene succinate adipate) (PBSA), polyanhydrides, such as poly(sebacic acid-co-hexadecanedioic acid anhydride) (poly(SA-HDA anhydride), polyorthoesters (POE), plasticized starch with poly(caprolactone), starch-based aliphatic polyesters, polyesteramides (PEA), and any combinations or blends of copolymers thereof.

In one embodiment, the biopolymers preferably comprise one or more biologically produced polymers, preferably polymers selected from the group comprising bacterial polyester polyhydroxyalkanoate (PHA), such as homopolymers and copolymers of 3-hydroxybutyric acid and 3-hydroxyvaleric acid, and poly(lactic acid)/polylactide resin (PLA), and combinations thereof.

The biopolymers have generally an average molecular weight of more than 500 g/mol, preferably more than 1000 g/mol.

It is preferred that the biopolymers contain little water, such as less than 1 wt % of water, preferably less than 0.5 wt % of water, based on the total amount of the biopolymers.

Starch/Protein Containing Materials

Suitable natural materials may include flour, milled expeller/meal/cake, milled pomace, milled distillers' grain, milled brewer's grain (or brewer's spent grain/draff), milled biscuit meal (or biscuit cereal meal), coffee grounds, cocoa bean shells, or combinations thereof.

The term “flour” concerns generally a composition having both starch and protein containing fractions originating from one and the same vegetable source, wherein the starch containing fraction and the protein containing fraction have not been separated from one another. Typical proteins present in the flours are globulins, albumins, glutenins, secalins, prolamins, glutelins. Other components originating from the vegetable source may be present likewise, such as cell wall or non-starch polysaccharides, fibres, lipids and ash. The flour may be subjected to any treatment, such as an enzymatic treatment, but its treated components are jointly introduced. The flour can be used entirely, without generating waste products.

Flour is derived from seeds, tubers, roots, grains or grasses. More extensively, flour may be derived from seeds, legumes, nuts, and grains, such as beans, kidney beans, soybeans, lentils, (yellow, green, wrinkled) pea, chickpea, lupins, wheat, buckwheat, triticale, millet (sorghum), canary seed, amaranth grain, corn, sago, barley, oat and rice. Additionally, flour may be derived from grasses, roots or tubers, such as potatoes, sweet potato, quinoa, arrow root, and cassava (tapioca). The flour may be derived from amylose-rich (amylo) or amylopectin-rich (waxy) plant resources.

Flour can be made of the whole grain (groat) or seed, including the hull and/or husk. Within this specification, the definition of grain includes groats, which are the hulled kernels of cereal grains, that include the cereal germ and fibre-rich bran portion of the grain, as well as the endosperm.

Chemically modified flour or flour derivatives may also be used, including purified/separated starch. Preferably flours are used that are not or slightly chemically modified, preferably phosphorylated.

It is preferred that the flour contains 60-95 wt %, based on the total mass of flour, carbohydrates, such as starch, sugars or non-starch polysaccharides, like pentosans, having generally an average molecular weight of more than 500 g/mol, preferably more than 1000 g/mol.

Expellers/meals/cakes are the remains from processed oilseeds, which are seeds primarily grown for the extraction of edible oils, although they may also include seeds grown for the purpose of oil extraction for any application, such as in fragrances and personal care. Whole oilseeds contain high concentrations of energy and moderate concentrations of protein and fiber. Major oilseeds include soybean, rapeseed (canola), sunflower, and palm oil.

The processes utilized in the extraction of the oil from the oilseed (defatting of the oilseed) essentially fall into three categories: solvent-extracted, hot-pressed (or expeller-extracted), and cold-pressed. Solvent extraction is commonly undertaken (industrially) using hexane, following mechanical crushing of the oilseeds, and results in removal of 97-99% of the oil content, with oil content <1.5% normally expected. Pressed extraction is done mechanically through physical squeezing of the oil from the oilseed with cold-pressing occurring below 60° C./140° F. Hot-pressing/expeller extraction involves heated pre-treatment of the oilseeds before pressing. Expected oil extraction content by pressing is normally <95%.

The remains of the oilseed following oil extraction are commonly referred to as meal, expeller, or cake (press-cake). More accurately, solvent extracted oilseed results in meal, hot-pressed extraction results in expeller meal, and cold-pressed extraction results in expeller cake. For the purposes of this patent, meal is defined as the resultant material of solvent extraction processes, containing less than 3% preferably equal to or less than 1.5 w/w of oil. For instance, solvent-extracted rapeseed meal must not contain more than 2-3% oil, see e.g. https://www.feedipedia.org/node/52, which is incorporated herein by reference.

Oilseed meals are a major source of protein in livestock feeds with protein levels usually in excess of 20%. Examples of commercial meals include, but are not limited to, soybean meal or soymeal, palm meal or palm kernel meal, coconut meal or copra meal, sunflower meal, peanut meal or groundnut meal, cottonseed meal, rapeseed meal or rapemeal or canola meal, castor bean meal, linseed meal, flaxseed meal or flaxmeal, safflower meal, camelina meal, corozo palm nut meal or corozo meal, grape seed meal, jatropha kernel meal, mustard seed meal, maize germ meal, sal seed meal or Shorea Robusta seed meal, sesame seed meal, hemp seed meal, tobacco seed meal, watermelon seed meal, niger seed meal, rice bran meal, wheat germ meal, borage meal, blackcurrant meal, evening primrose meal, rosehip meal, Buglossoides arvensis (Ahiflower) meal, jojoba meal, and almond meal, for example.

Pomace, or marc, is the name given to the solid remains of juice/oil-bearing fruits or vegetables following pressing for the removal of the juice/oil. Common fruits that are known to produce pomace include grape, olive, blackcurrant, orange, pineapple, and apple for example. Pomace normally comprises the skins, pulp, seeds, and stems of the fruit. Pomace can also be produced as a by-product of vegetable juice/oil processing, such as carrot and beetroot for example. Fruit pomace usually comprises 20-50% w/w of the original fruit mass whereas vegetable pomace normally comprises >30% w/w of the original vegetable mass.

Distillers' grains are the cereal by-product of a fermentation or distillation process, whereas brewers' grain, or brewer's spent grain, usually specifically refers to the residual barley (or in a mixture with other cereal grains or grain products) produced as a by-product of beer brewing, collected before fermentation of the wort. The majority of brewers' grain comprises barley malt grain husks in combination with parts of the pericarp and seed coat layers of the barley. Distillers' grains are normally a mix of corn, rice and other grains that have come from either brewing or the production of ethanol biofuels. For the purposes of this patent, the use of the term spent grains will encompass distillers' grains and brewers' grains.

Distillers' grains are available as wet distillers' grains, containing primarily unfermented grain residues (protein, fibre, fat and up to 70% moisture), and as dried distillers' grains with solubles, which is wet distillers' grains that has been dried with the concentrated thin stillage to 10-12% moisture or less. Dried distillers' grains are a complex composition of protein (26.8-33.7% dry weight basis), carbohydrates (39.2-61.9%), oils (3.5-12.8%), and ash (2.0-9.8%). The definition of spent grains refers to dried distillers' grains and/or dried brewers' spent grain that have optionally been further solvent treated to remove solubles and/or oils.

Biscuit meal, or biscuit cereal meal, may include either a mixture of or the individual components of the crumbed waste of cooked and processed biscuit, cake and cereal food products.

Coffee grounds are the left-over grains of filter coffee once the solubles have been extracted by treatment with boiling water. Wet coffee grounds are then conditioned, dried and classified to create a dry powder. Coffee grounds primarily contain carbohydrates (45%), alkaloids (17%), lignin (14%), lipids (11%), and proteins (10%).

Cocoa shells (or cocoa bean shells) are the shells (or hull) that are separated from the cocoa bean during the roasting process. Cocoa shells are rich in dietary fibres, proteins, and polyphenols.

Feldspars

Feldspars are a group of rock-forming aluminium tectosilicate minerals, containing also other cations such as sodium, calcium, potassium, or barium. The most common members of the feldspar group are the plagioclase (sodium-calcium) feldspars and the alkali (potassium-sodium) feldspars (named alkali due to their alkali metals and not their pH range).

The composition of feldspars resides in the ternary phase diagram between potassium feldspar (KAlSi₃O₈)—albite (NaAlSi₃O₈)—anorthite (CaAl₂Si₂O₈). Barium feldspars form as the result of the substitution of barium for potassium in the mineral structure.

The preferred form in this embodiment is nepheline syenite due to its absence of crystalline silica (quartz), low refractive index being similar to polylactide resin (1.5) and its transparency to UV radiation thus aiding biodegradation of the biopolymer(s).

Additives

Optional additives include plasticizers for the biopolymers, consisting of compounds such as citric acid esters, such as acetyl tributyl citrate, acetyl triethyl citrate, tributyl citrate or triethyl citrate, substituted adipate esters, such as di(2-ethylhexyl) adipate, dihexyl adipate, dioctyl adipate, substituted sebacate esters, such as dibutyl sebacate, and oligomeric lactic acid (OLA). Vegetable oils or epoxidized vegetable oils, such as epoxidized soybean oil and epoxidized linseed oil, are natural plasticizers for biopolymers (for example U.S. Pat. No. 10,590,261). Optional additives may further comprise additives known in the art, such as compatibilizers, antioxidants, lubricants, dyes, pigments, fragrances, odorants, liquid or gas absorbers, small molecules absorbents, flame retardants, oxygen and/or water vapour barrier additives, ultraviolet absorbers or stabilizers, heat stabilizers, infrared absorbers or blockers, melt flow accelerators, impact modifiers, nucleating agents, surfactants, chelating agents, coupling agents, adhesives, primers, reinforcement agents, inert fillers, fungicides, herbicides, fertilizers and opacifiers, compounds with rodent-repellent effects, and waxes, ideally not of an acidic (pH<7) nature that will interfere with the feldspar—natural material association.

Additive addition or partial substitution of the nepheline syenite with bentonite (pH=7-10) has also been found to be advantageous in improving both the oxygen and water vapour barrier properties of the composite. Bentonite nanoclays are commonly used as additives in plastics to improve the barrier properties, and coatings made with mixtures of bentonite, starch and plasticizer have proved to increase the water barrier properties of treated substrates (for example Applied Clay Science 2019, 183, 105272).

Zeolites can be considered as liquid or gas absorbers/absorbents that can be added to plastics to absorb undesirable odours, reduce VOC emissions, act as free radical scavengers, and act as moisture absorbent desiccants (for example Journal of Cleaner Production 2021, 295, 126379). Additive addition or partial substitution of the nepheline syenite with zeolites that have pH>7 are also possible.

Reinforcement agents and inert fillers may include natural cellulosic/lignocellulosic plant fibres from the husks (skins) or stems of bast, including jute, flax, hemp, isora, mesta, kenaf, ramie, toina, totora, urena, banana, roselle, rattan, and nettle; leaf, including sisal, henequin, manila, curaua, pineapple, palm (areca), yucca, piassava, cabuja, opuntia, agaves, abaca; seed, including cotton, calotropis, poplar, kapok; fruit, including coconut, luffa, coir, cocoa; grasses/reeds including bamboo, bagasse, wheat, oat, rape, rye, rice, esparto, barley, corn; straw, reeds and grasses; wood, including hard wood and soft wood. Other natural fibres include silk, wool and hair.

Biodegradability

Biodegradability of polymers or compositions can be defined as the physical and/or chemical degradation at the molecular level of the substances by the action of environmental factors, particularly the enzymes stemming from the metabolic, processes of microorganisms. With “biodegradable” it is preferably understood that the biocomposite resin products satisfy the European Union harmonized standard EN 13432 or the American Society for Testing and Materials ASTM D6400 for example. These standards specify the criteria for biodegradation, disintegration, and eco-toxicity for a plastic to be called compostable. It is preferred that the biocomposite resin complies with at least one of these standards. Biodegradability is typically determined by measuring the amount of CO₂ produced over a certain time period by the biodegrading material. The EN 13432 standard requires 90% biodegradation within 180 days whereas the ASTM standard requires 60% biodegradation.

Processability

The polymer composite described above may be made by so-called “hot compounding” techniques, where the components are combined under heat and shearing forces that bring about a state of molten plastic (fluxing) which is shaped into the desired product, cooled, and allowed to develop ultimate properties of strength and integrity. Hot compounding techniques include calendering, extrusion, injection, and compression moulding.

In an embodiment, the process described above is carried out at temperatures, pressures and processing conditions specific to the selected polymer, e.g. at temperatures in the range of 130 to 215° C., which may be very suitable for PLA, preferably between 165 and 180° C.

The polymer composite may also be made by a multistep process, wherein for instance the starch and/or protein containing material is first compounded with the micronized feldspar and pelletized and the pellets or ground pellets are then combined with the polymer.

Additional components may be added in any of the steps of the multistep process. The present invention therefore also provides pellets or ground pellets of starch and/or protein containing material compounded and pelletized with micronized feldspar and other components if any, as intermediate product for combination with the polymer to produce the polymer composite.

The result of the process can be in the form of a solid article (or layer or portion thereof) and may comprise a compounded pellet, extruded work-piece, injection-moulded article, blow moulded article, film or rota-moulded plastics article, two-part liquid moulded article, laminate, 3D printer filament, felt, woven fabric, knitted fabric, embroidered fabric, nonwoven fabric, geotextiles, fibres or a solid sheet, for example.

The solid article may be in the form of a coffee pod, cutlery, food tray, or single-serve packaging.

Embodiments of the invention are illustrated by the examples below.

### Example 1

3 kgs of starch flour was mixed with 3 kgs of nepheline syenite powder in a planetary mixer to create a homogenous powder of about 6 kgs weight. This mixture was then compounded with Ingeo 3251D PLA in a ratio of 30:70 starch/syenite:PLA on a Werner and Pfleiderer ZSK 25 twin-screw compounder fitted with a ZS-B 25 twin-screw side feeder. The screw profile used is given in Table 1 along with the respective injection points for the component materials. The temperature settings along the barrel were 170, 190, 170, 170, 170, 170, 170, 170° C. The compounded filament was cooled in a water bath, dried under an air knife and pelletized using a SG-E 60 from Intelligent Pelletizing Solutions GmbH & Co KG. Pellets were dried overnight in a Dryplus 25 from Vismec s.r.l at 60° C.

TABLE 1
Screw profile with material inclusion points:

| Conveying | 16/16 (PLA) |
|---|---|
| | 36/36 (×2) |
| | 36/18 |
| | 36/36 |
| | 36/18 |
| Kneading | 45/5/36 |
| | 45/5/18 |
| | 45/5/18 (×2) |
| Conveying | 36/36 (×5) |
| | (starch/syenite) |
| Kneading | 45/5/36 (×3) |
| Conveying | 36/36 |
| Kneading | 45/5/24 (×3) |
| Conveying | 16/16 |
| | 36/36 (×2) |
| Kneading | 45/5/12 (×2) |
| | 90/5/24 |
| Conveying | 36/36 |
| Kneading | 45/5/12 (×2) |
| | 45/5/12 |
| Conveying | 36/36 (×5) |
| | 24/24 (×4) |

### Example 2

3 kgs of starch flour was mixed with 3 kgs of nepheline syenite powder in a planetary mixer to create a homogenous powder of about 6 kgs weight. This mixture was then compounded with Ingeo 3251D PLA in a ratio of 40:60 flour/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

### Example 3

3 kgs of wheat flour was mixed with 3 kgs of nepheline syenite powder in a planetary mixer to create a homogenous powder of about 6 kgs weight. This mixture was then compounded with Ingeo 3251D PLA in a ratio of 30:70 flour/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

### Example 4

3 kgs of wheat flour was mixed with 3 kgs of nepheline syenite powder in a planetary mixer to create a homogenous powder of about 6 kgs weight. This mixture was then compounded with Ingeo 3251D PLA in a ratio of 40:60 flour/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

### Example 5

3 kgs of pea flour (made from blue field peas milled in a Magico EMC70 electric mill from AMA S.p.A. fitted with a 1 mm sieve) was mixed with 3 kgs of nepheline syenite powder in a planetary mixer to create a homogenous powder of about 6 kgs weight. This mixture was then compounded with Ingeo 3251D PLA in a ratio of 30:70 flour/syenite:PLA on a Werner and Pfleiderer ZSK 25 twin-screw compounder fitted with a ZS-B 25 twin-screw side feeder.

The screw profile used is given in Table 1 and the respective injection points for the component materials were as per Example 1. All other details were as per Example 1.

### Example 6

3 kgs of bean flour (made from winter faba beans milled in a Magico EMC70 electric mill from AMA S.p.A. fitted with a 1 mm sieve) was mixed with 3 kgs of nepheline syenite powder in a planetary mixer to create a homogenous powder of about 6 kgs weight. This mixture was then compounded with Ingeo 3251D PLA in a ratio of 30:70 flour/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

### Example 7

3 kgs of evening primrose meal powder (milled in a Magico EMC70 electric mill from AMA S.p.A. fitted with a 1 mm sieve) was mixed with 3 kgs of nepheline syenite powder in a planetary mixer to create a homogenous powder of about 6 kgs weight. This mixture was then compounded with Ingeo 3251D PLA (incorporating 2% w/w maleic anhydride grafted PLA) in a ratio of 30:70 meal/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

### Example 8

3 kgs of rosehip meal powder (milled in a Magico EMC70 electric mill from AMA S.p.A. fitted with a 1 mm sieve) was mixed with 3 kgs of nepheline syenite powder in a planetary mixer to create a homogenous powder of about 6 kgs weight. This mixture was then compounded with Ingeo 3251D PLA (incorporating 2% w/w maleic anhydride grafted PLA) in a ratio of 30:70 meal/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

### Example 9

3 kgs of coffee grounds was mixed with 3 kgs of nepheline syenite powder in a planetary mixer to create a homogenous powder of about 6 kgs weight. This mixture was then compounded with Ingeo 3251D PLA in a ratio of 30:70 grounds/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

### Example 10

3 kgs of triticale flour was mixed with 3 kgs of nepheline syenite powder in a planetary mixer to create a homogenous powder of about 6 kgs weight. This mixture was then compounded with Ingeo 2003D PLA in a ratio of 30:70 flour/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

### Example 11

3 kgs of coffee grounds was mixed with 3 kgs of nepheline syenite powder in a planetary mixer to create a homogenous powder of about 6 kgs weight. This mixture was then compounded with Ingeo 2003D PLA in a ratio of 30:70 grounds/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

### Example 12

3 kgs of starch flour was mixed with 3 kgs of nepheline syenite powder in a planetary mixer to create a homogenous powder of about 6 kgs weight. This mixture was then compounded with BioPBS FZ71PM in a ratio of 30:70 starch/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1 except that all the barrel temperatures were set 10° C. higher.

### Example 13

3 kgs of starch flour was mixed with 3 kgs of nepheline syenite powder in a planetary mixer to create a homogenous powder of about 6 kgs weight. This mixture was then compounded with DAN-02925 PHA in a ratio of 30:70 starch/syenite:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

### Examples 14-26

Compounded pellets from Examples 1 and 13 were separately fed into the hopper of a Krauss Maffei 120-250 PX injection moulding machine with a 40 mm diameter screw operating at temperatures ranging from 175 to 200° C. Each molten plasticized mixture was injection moulded in a single-cavity cold sprue and runner edge-gate tool running at 20° C. into plaques of dimensions 81×27×0.8/1.0/1.5 mm (three-step plaque).

### Examples 27-28

Compounded pellets from Examples 1 and 3 were separately fed into the hopper of a Krauss Maffei 120-250 PX injection moulding machine with a 40 mm diameter screw operating at temperatures ranging from 175 to 200° C. Each molten plasticized mixture was injection moulded in a ten-cavity hot sprue bush sub-gated tool running at 28° C. of either a full-size cutlery fork or a full-size cutlery knife (two separate tools).

### Examples 29-30

Compounded pellets from Examples 2 and 4 were separately fed into the hopper of a Krauss Maffei 120-250 PX injection moulding machine with a 40 mm diameter screw operating at temperatures ranging from 180 to 210° C. Each molten plasticized mixture was injection moulded in an eight-cavity tool running at 28° C. fitted with a valve-gate hotrunner system into capsules suitable for use in a Nespresso®-style coffee machine. Representative coffee capsules from both materials were then filled to level capacity with ground coffee grains and sealed with self-sealing aluminium coffee capsule lids. Filled capsules were tested in a standard Nespresso coffee machine to produce a volume of filtered coffee. All capsules produced approximately the same volume of coffee as expelled from a commercial Nespresso capsule.

### Example 31

Representative samples of the knives and forks made in Examples 27 and 28 were used to consume a meal consisting of two fried eggs, two cooked sausages, two rashers of bacon and a serving of heated baked beans. All cutlery pieces tested had sufficient strength to both stab and/or cut each food item into edible pieces without deformation or breakage.

### Example 32

Compounded pellets from Examples 10 and 11 were separately fed into the hopper of a Baopin Precision Instruments 25 mm single-screw sheet extruder operating 170-180° C. that produced 200 mm wide extruded sheets of both materials.

### Example 33

27×27×0.8 mm plaques from Example 16 were subject to disintegration experiments conducted using procedures from ISO 20200 Plastics—Determination of the degree of disintegration of plastic materials under simulated composting conditions in a laboratory-scale test. Three reactors, sealed plastic tubs with holes drilled in the side for pressure equalization, each containing between 0.5-2% by weight plaques were placed inside a Binder KB240 incubator set at 58° C. Upon completion of the ninety days the average disintegration, D, was 66%; the average decrease in volatile-solids content, R, was 41%; and the variability of results was 10%. Thus, the test was considered valid.

### Comparative Example 1

3 kgs of starch flour was mixed with 3 kgs of calcium carbonate (CaCO₃) powder in a planetary mixer to create a homogenous powder of about 6 kgs weight. This mixture was then compounded with Ingeo 3251D PLA in a ratio of 30:70 starch/CaCO₃:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

Compounded pellets were fed into the hopper of a Krauss Maffei 120-250 PX injection moulding machine with a 40 mm diameter screw operating at temperatures ranging from 175 to 200° C. The molten plasticized mixture was injection moulded in a single-cavity cold sprue and runner edge-gate tool running at 20° C. into plaques of dimensions 81×27×0.8/1.0/1.5 mm (three-step plaque).

Compounded pellets were fed into the hopper of a Krauss Maffei 120-250 PX injection moulding machine with a 40 mm diameter screw operating at temperatures ranging from 175 to 200° C. The molten plasticized mixture was injection moulded in a ten-cavity hot sprue bush sub-gated tool running at 28° C. of either a full-size cutlery fork or a full-size cutlery knife (two separate tools).

### Comparative Example 2

3 kgs of wheat flour was mixed with 3 kgs of CaCO₃ powder in a planetary mixer to create a homogenous powder of about 6 kgs weight. This mixture was then compounded with Ingeo 3251D PLA in a ratio of 30:70 flour/CaCO₃:PLA on a Werner and Pfleiderer ZSK 25 twin-screw compounder fitted with a ZS-B 25 twin-screw side feeder. The screw profile used is given in Table 1 and the respective injection points for the component materials were as per Example 1. All other details were as per Example 1.

Compounded pellets were fed into the hopper of a Krauss Maffei 120-250 PX injection moulding machine with a 40 mm diameter screw operating at temperatures ranging from 175 to 200° C. The molten plasticized mixture was injection moulded in a single-cavity cold sprue and runner edge-gate tool running at 20° C. into plaques of dimensions 81×27×0.8/1.0/1.5 mm (three-step plaque).

Compounded pellets were fed into the hopper of a Krauss Maffei 120-250 PX injection moulding machine with a 40 mm diameter screw operating at temperatures ranging from 175 to 200° C. The molten plasticized mixture was injection moulded in a ten-cavity hot sprue bush sub-gated tool running at 28° C. of either a full-size cutlery fork or a full-size cutlery knife (two separate tools).

### Comparative Example 3

Representative samples of the knives and forks made in Comparative examples 1 and 2 were used to consume a meal consisting of two fried eggs, two cooked sausages, two rashers of bacon and a serving of heated baked beans. Cutlery made with calcium carbonate was noticeably more brittle than those made with nepheline syenite and some of the pieces tested broke on both stabbing and/or cutting the sausages. This difference in strength was also evident in the plaques where there was a noticeable difference in how much more brittle the plaques made from calcium carbonate were to those containing nepheline syenite. This difference was not just due to the difference in hardness between the two because comparative plaques made from materials just containing PLA and the respective minerals (mixed in equivalent percentages at 17.65% w/w) did not display such a difference in brittleness.

### Comparative Example 4

Representative plaques (27×27×1.5 mm) from Example 14 and Comparative example 1 were examined for overall migration according to Commission Regulation (EU) No 10/2011 on plastic materials and articles intended to come into contact with food. For each simulant, four plaques were held vertically in a custom-made holder and immersed in 100 mL simulant in a sealed lidded glass jar. Experiments were run in triplicate, plus two blanks (i.e., without plaques). Both sets of plaques were tested in simulant A 10% v/v ethanol and simulant B 3% v/v acetic acid for 2 hrs at 70° C. (OM3). The results obtained for plaques from Example 14 were 0.77 g/dm³ from simulant A and 0.39 g/dm³ from simulant B; whereas for plaques from Comparative example 1 the results were 7.97 g/dm³ from simulant A and 39.87 g/dm³ from simulant B. The overall migration results for simulant B on plaques made from calcium carbonate (Comparative example 1) are in excess of the 10 g/dm³ limit as set by Commission Regulation (EU) No 10/2011.

What is claimed is:

1. Polymer composite having an overall weight, comprising:
biodegradable polymer in an amount of 1-98% by weight of the overall weight;
micronized feldspar in an amount of at least 1% by weight of the overall weight; and
starch and/or protein containing material in an amount of at least 1% by weight of the overall weight.

2. The polymer composite of claim 1, wherein no plasticizer for the starch and/or protein containing material is present.

3. The polymer composite of claim 1, further comprising a plasticizer for the starch and/or protein containing material at most 40% by weight of the starch and/or protein containing material.

4. The polymer composite of claim 1, wherein the biodegradable polymer is chosen from PLA, PBS, PBAT, PHA, derivatives thereof, and polymer blends thereof.

5. The polymer composite of claim 4, wherein the biodegradable polymer is present in an amount of 30-70% by weight of the overall weight.

6. The polymer composite of claim 1, wherein the micronized feldspar comprises micronized nepheline syenite.

7. The polymer composite of claim 1, wherein the starch and/or protein containing material is chosen from flour derived from seeds, tubers, roots, grains, or grasses; milled expeller/meal/cake, milled pomace, milled distillers' grain, milled brewer's grain (or brewer's spent grain/draff), milled biscuit meal (or biscuit cereal meal), coffee grounds, cocoa shells, and combinations thereof.

8. The polymer composite of claim 1, further comprising an additive chosen from plasticizers for the biodegradable polymer, compatibilizers, antioxidants, lubricants, dyes, pigments, fragrances, odorants, liquid or gas absorbers, small molecules absorbents, flame retardants, oxygen and/or water vapor barrier additives, ultraviolet absorbers or stabilizers, heat stabilizers, infrared absorbers or blockers, melt flow accelerators, impact modifiers, nucleating agents, surfactants, chelating agents, coupling agents, adhesives, primers, reinforcement agents, inert fillers, fungicides, herbicides, fertilizers and opacifiers, compounds with rodent-repellent effects, waxes, and mixtures thereof.

9. A process for preparing a polymer composite, comprising: combining a biodegradable polymer, micronized feldspar, and starch and/or protein containing material, forming a mixture; melting the mixture forming a molten mixture; forming the molten mixture into a desired product; and cooling the desired product.

10. The process of claim 9, wherein the polymer composite is formed into the desired product by calendering, extrusion, injection, or compression moulding.

11. The process of claim 9, wherein said step of melting the mixture is performed at temperatures in the range of 130 to 215° C.

12. The process of claim 9, further comprising the steps of combining the micronized feldspar with the starch and/or protein containing material forming a second mixture; pelletizing or grinding the second mixture; and combining the second mixture with a biodegradable polymer forming a third mixture, before melting the third mixture forming a molten mixture.

13. A solid article comprising the polymer composite as claimed in claim 1.

14. The solid article of claim 13, wherein the solid article is formed into an article chosen from a compounded pellet, extruded workpiece, injection-moulded article, blow moulded article, rota-moulded plastic article, two-part liquid moulded article, laminate, 3D printer filament, felt, woven fabric, knitted fabric, embroidered fabric, nonwoven fabric, geotextiles, fibre, and a solid sheet.

15. The solid article of claim 13, wherein the solid article is formed into an article chosen from a coffee capsule, cutlery, straw, drink stirrer, food tray, single-serve packaging, such as a cup, cap, container and/or lid, and any other single-use item.
